(19) United States
(12) Patent Application Publication
(10) Pub. No.: US 2024/0052931 A1
(43) Pub. Date: Feb. 15, 2024

(54) Butterfly valve assembly, in particular for a gas flow in a fuel cell system

(71) Applicant: Purem GmbH, Neunkirchen (DE)

(72) Inventors: Markus Lory, Stuttgart (DE); Matthias Grün, Altbach (DE); Andreas Wacker, Plochingen (DE); Jochen Hammer, Stuttgart (DE)

(21) Appl. No.: 18/447,690

(22) Filed: Aug. 10, 2023

(30) Foreign Application Priority Data
Aug. 11, 2022 (DE) 10 2022 120 289.5
Jul. 5, 2023 (EP) 23 183 539.8

(51) Int. Cl. F16K 1/226; F16K 1/22

(52) U.S. Cl. CPC F16K 1/2261; F16K 1/222

(57) ABSTRACT

A butterfly valve assembly includes a butterfly valve housing defining a channel for accommodating a flow of gas therethrough. The assembly includes a butterfly valve adjustable in the housing between a closed position preventing the flow of gas through the channel and an open position opening up the channel for allowing passage of the flow of gas. A pivot shaft is rotatable about a pivot shaft axis and has first and second pivot shaft end portions corresponding to first and second bearing regions. A disk-shaped butterfly valve element is supported on the pivot shaft. At least one of the first and second bearing regions includes a bearing unit rotatably supporting the pivot shaft. The pivot shaft has an outer peripheral surface. At least one seal is subject to an axial load by the bearing unit and lies against the outer peripheral surface of the pivot shaft.

### CROSS-REFERENCE TO RELATED APPLICATIONS

This application claims priority of German patent application no. 10 2022 120 289.5, filed Aug. 11, 2022, and European patent application no. 23 183 539.8, filed Jul. 5, 2023, the entire contents of which are incorporated herein by reference.

### TECHNICAL FIELD

The present disclosure relates to a butterfly valve assembly that can be used for example for a gas flow in a fuel cell system, in particular in a vehicle, for the purposes of providing electrical energy.

### BACKGROUND

In such fuel cell systems, depending on the operating state, it is necessary to conduct different gas flows through or past the anode region, and through or past the cathode region, of a fuel cell or of a fuel cell stack. Here, stringent demands are placed on the leak-tightness of butterfly valve assemblies used to regulate such gas flows, in order to ensure, in particular in operating states in which a particular gas flow should not be conducted through a fuel cell or should not be conducted past a fuel cell, that leakage flows can be ruled out and substantially no gas can escape to the surroundings.

### SUMMARY

It is an object of the present disclosure to provide a butterfly valve assembly, in particular for a gas flow in a fuel cell system, in particular in a vehicle, which butterfly valve assembly can substantially prevent gas leakage while being of structurally simple configuration.

This object is, for example, achieved according to the disclosure via a butterfly valve assembly, in particular for a gas flow in a fuel cell system, in particular in a vehicle, including a butterfly valve housing which provides a gas flow channel, a butterfly valve which is adjustable in the butterfly valve housing between a closed position, substantially preventing a gas flow through the gas flow channel, and at least one open position, opening up the gas flow channel for a passage of flow, and which has a disk-shaped butterfly valve element supported on a pivot shaft which is rotatable about a pivot shaft axis, the pivot shaft having a first pivot shaft end portion, which is provided for coupling to a pivot shaft drive and which in a first bearing region is supported rotatably about the pivot shaft axis on the butterfly valve housing, and a second pivot shaft end portion, which in a second bearing region is supported rotatably about the pivot shaft axis on the butterfly valve housing, at least one bearing region out of the first bearing region and second bearing region including a bearing unit, which rotatably supports the pivot shaft, and at least one sealing element, which is subjected to axial load by the bearing unit and which lies against an outer circumferential surface of the pivot shaft.

Through the provision of the at least one sealing element that lies against the outer circumferential surface of the pivot shaft, it is ensured that, even if bearing play arises in the region of the at least one bearing unit, tight closure of the butterfly valve assembly that prevents an escape of gas is achieved.

Since the first pivot shaft end portion of the pivot shaft has to be led through the associated first bearing region in order to enable coupling to the pivot shaft drive, it is particularly conducive to gas-tight closure if the at least one bearing region is the first bearing region. In the second bearing region, in which the pivot shaft does not need to be led with its second pivot shaft axis through the bearing region or out of the bearing region, a gas-tight closure can be implemented by other measures, for example complete encapsulation of the second pivot shaft end portion via a bearing bushing.

To achieve a completely gas-tight connection of the at least one sealing element to the pivot shaft over the entire circumference of the pivot shaft, it is proposed that the at least one sealing element annularly surrounds the pivot shaft axis, and/or that the bearing unit annularly surrounds the pivot shaft axis.

In order to be able to firstly ensure stable positioning of the sealing element in the structural material of the bearing unit, and secondly ensure interaction with the pivot shaft that leads to adequate sealing, the at least one sealing element may include a holding portion, which is subjected to axial load by the bearing unit, and a sealing portion, which lies against the pivot shaft.

Here, in order to obtain an axially compact structure, the holding portion may extend substantially radially, and the sealing portion may extend radially inward from the holding portion toward the pivot shaft. Here, the at least one sealing element is thus substantially in the shape of an annular disk.

For defined axial clamping of the at least one sealing element, the bearing unit may include at least one bearing ring, and the holding portion of the at least one sealing element may be held between the at least one bearing ring and a base of a bearing bushing of the at least one bearing region and/or between the at least one bearing ring and the butterfly valve housing.

In order to be able to provide areal support for the at least one sealing element, it is proposed that, in its region which supports the at least one sealing element, the base of the bearing bushing, and/or the butterfly valve housing, is oriented substantially orthogonally with respect to the pivot shaft axis and is substantially planar.

In order to be able to reliably maintain the load-exerting action generated by the at least one bearing ring, it is proposed that the at least one bearing ring is held in the bearing bushing with an interference fit.

For a configuration that requires little maintenance, the bearing unit may be a plain bearing unit.

To implement the required sealing function, the at least one sealing element may be constructed with elastomer material.

The present disclosure furthermore relates to a method for producing a butterfly valve assembly constructed in accordance with the disclosure, including the measures:
a) arranging the at least one sealing element in a bearing bushing of the at least one bearing region,
b) pressing at least one bearing ring of the bearing unit into the bearing bushing such that the at least one bearing ring subjects the at least one sealing element to axial load and the at least one sealing element is deformed radially inward by the axial load.

The pressing-in of the at least one bearing ring causes such an axial load to be exerted on the at least one sealing element that the latter deflects radially inward, and a reliable sealing action is achieved as a result of the at least one sealing element abutting radially against the pivot shaft.

Here, the measures a) and b) may be carried out after the pivot shaft has been positioned so as to engage with one of its pivot shaft end portions into the bearing bushing of the at least one bearing region. In this approach, the at least one sealing element, and subsequently the at least one bearing ring, are positioned in the bearing bushing so as to encompass the pivot shaft end portion. Here, the at least one bearing ring is loaded in the direction of the sealing element that encompasses the pivot shaft end portion, in such a way that the at least one bearing ring subjects the at least one sealing element to axial load, and the sealing element is thus deformed, or deflects, radially inward in the direction of the pivot shaft that is already extending through the sealing element.

In an alternative approach, the measures a) and b) may be carried out before the pivot shaft is positioned so as to engage with one of its pivot shaft end portions into the bearing bushing of the at least one bearing region. For example, the at least one sealing element and the at least one bearing ring may be positioned in the bearing bushing before the bearing bushing is arranged on and fixed to the butterfly valve housing, which already contains the butterfly valve and thus also the pivot shaft.

The disclosure furthermore relates to a fuel cell system, in particular for a vehicle, including at least one butterfly valve assembly according to the disclosure, preferably produced by way of a method according to the disclosure.

### BRIEF OF DRAWINGS

The invention will now be described with reference to the drawings wherein:

FIG. 1 shows a schematic diagram of a fuel cell system of a vehicle;

FIG. 2 shows a butterfly valve assembly for a fuel cell system; and,

FIG. 3 shows a sectional view of a bearing region for a pivot shaft of the butterfly valve assembly.

### DETAILED DESCRIPTION

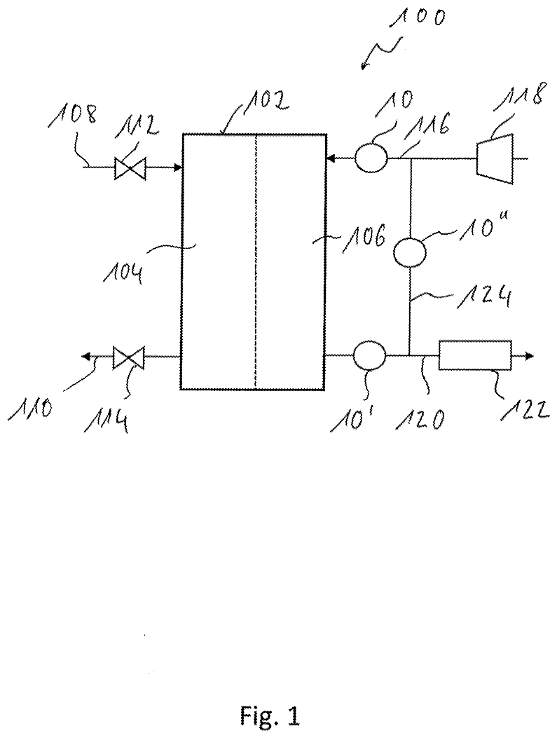

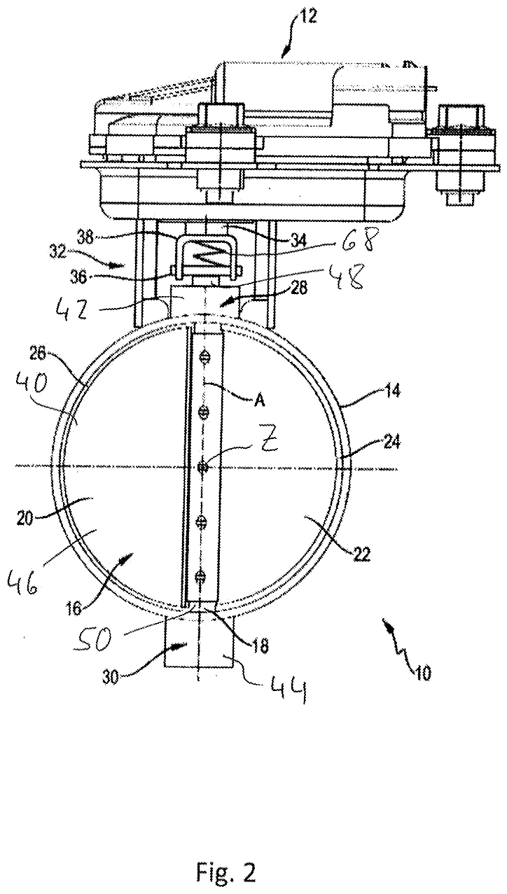

Before the embodiment according to the disclosure of a butterfly valve assembly for a fuel cell system is described in detail below, in particular with regard to a structure thereof which is intended for providing a sealed closure, the basic construction of a fuel cell system which can be used to provide electrical energy in a vehicle will be described with reference to FIG. 1, and the basic construction of a butterfly valve assembly which, in particular when assigned to the cathode region of such a fuel cell system, can be used to regulate the gas flow or shut off a flow through the cathode region, will be discussed with reference to FIG. 2.

The fuel cell system 100 illustrated in FIG. 1 includes, as a main system region, a fuel cell denoted generally by 102, having an anode region 104, which is to be fed with hydrogen or with a gas containing hydrogen, and having a cathode region 106, which is to be fed with oxygen or with a gas containing oxygen, for example air.

The anode region 104 is assigned a feed line 108 and a discharge line 110 with respective valves 112, 114 in order to allow the hydrogen or the gas containing hydrogen to be introduced into the anode region 104 and/or to allow anode off-gas to be discharged therefrom, and if necessary to allow the anode region 104 to be closed off entirely.

The cathode region 106 is assigned a feed line 116 via which the gas containing oxygen, for example air, can be introduced into the cathode region, for example via a compressor 118 or the like. A butterfly valve assembly denoted generally by 10 is provided in the feed line 116, via which butterfly valve assembly the gas flow via the feed line 116 can be regulated, or the cathode region 106 can be substantially gas-tightly closed off in its inlet region.

For the discharge of cathode off-gas, the cathode region 106 is assigned a discharge line 120. This leads to a fuel cell off-gas system 122 in which, for example, water contained in the cathode off-gas can be separated off using a water separator. Also arranged in the discharge line 120 is a further butterfly valve assembly 10′ via which the discharge line 120 and thus outlet region of the cathode region 106 can be substantially gas-tightly closed off.

A bypass line 124 runs between the feed line 116 and the discharge line 120 of the cathode region 106. A butterfly valve assembly 10″ is also arranged in the bypass line 124, via which butterfly valve assembly the gas flow via the bypass line 124 can be regulated or the bypass line 124 can be substantially gas-tightly closed off.

The construction of the fuel cell system 100 as illustrated in FIG. 1 and described above represents one example out of numerous different possibilities for the feed and discharge of gas, in particular at the cathode region 106. It is essential that at least one and optionally several butterfly valve assemblies 10, 10′, 10″ are provided so as to be assigned to the cathode region 106, wherein, if several such butterfly valve assemblies 10, 10′, 10″ are provided, these may in principle be structurally identical to one another, or may also be of different configuration depending on the region in which they are positioned and what degree of gas-tightness they are intended to provide.

The butterfly valve assembly 10 illustrated in FIG. 2 and used for example in the fuel cell system 100 of FIG. 1 includes a butterfly valve drive 12 based for example on an electric motor and includes, in a butterfly valve housing 14 which is tubular and bounds a gas flow channel 46, a butterfly valve denoted generally by 16.

The butterfly valve 16 includes a disk-shaped butterfly valve element 24 which is supported so as to be pivotable about a pivot shaft 18 axis A and which has two butterfly valve element parts 20, 22, which each provide one valve wing. A butterfly valve seat 26 is provided on the butterfly valve housing 14 so as to be assigned to the butterfly valve 16, against which butterfly valve seat the butterfly valve 16 lies, when in a closed position, by way of a closure region 40 which is situated radially at the outside in relation to a central region Z of the butterfly valve 16.

To move the butterfly valve 16 between the closed position and a fully opened position, in which the disk-shaped butterfly valve element 24 is oriented substantially orthogonally with respect to the plane of the drawing and FIG. 1 and thus substantially completely opens up the gas flow channel 46 in the butterfly valve housing 14 for a passage of flow, a drive shaft 34 of the butterfly valve drive 12 is coupled rotationally conjointly to the pivot shaft 18, which is supported in bearing regions 28, 30 on the butterfly valve housing 14 so as to be pivotable about the pivot shaft axis A, via a coupling arrangement 32. Here, the coupling arrangement 32 includes, for example, a coupling part 38, which is connected rotationally conjointly to the drive shaft 34, and a coupling part 36, which is connected rotationally conjointly to the pivot shaft 18 and which engages with the coupling part 38 with rotational coupling action.

Each of the two bearing regions 28, 30 includes a bearing bushing 42, 44, which is supported on the butterfly valve housing 14 and which is for example fixed to an outer circumferential surface thereof by welding and in which a respective axial end portion of the pivot shaft 18 is received so as to be rotatable about the pivot shaft axis A.

Of the two bearing regions 28, 30, the bearing region 28 forms a first bearing region in which a first pivot shaft end portion 48 of the pivot shaft 18 is rotatably mounted. The first pivot shaft end portion 48 projects axially beyond the first bearing region 28 in order to be coupled via the coupling arrangement 32 to the drive shaft 34. The bearing region 30 forms a second bearing region in which a second pivot shaft end portion 50 of the pivot shaft 18 is mounted so as to be rotatable about the pivot shaft axis A.

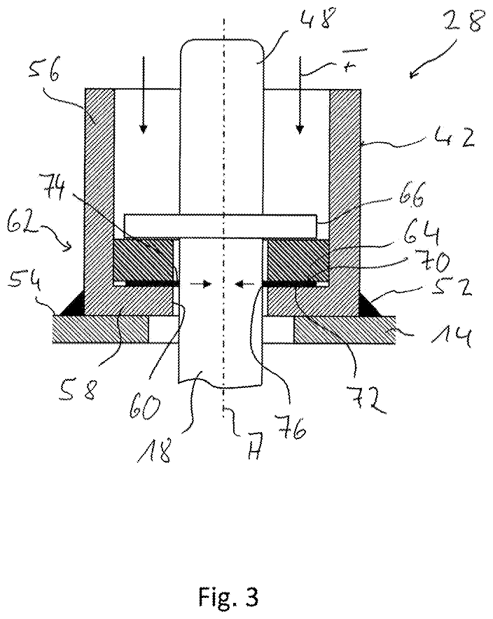

FIG. 3 illustrates the first bearing region 28 in detail. The first bearing region 28 includes the bearing bushing 42, which is, for example, fixed gas-tightly to the outer circumferential surface 54 of the butterfly valve housing 14 by a fully encircling weld seam 52. The bearing bushing 42 includes a circumferential wall 56 and a base 58 which adjoins the circumferential wall and which has an opening 60 through which the pivot shaft 18 extends. The bearing bushing 42 may also have only the circumferential wall 56 and no base wall, which, in particular in the case of the domed contour of the outer circumferential surface 54 of the butterfly valve housing 14, allows the bearing bushing 42 to be more easily fixed to the butterfly valve housing 14, also allows a configuration of the bearing bushing 42 which is easier to produce.

A bearing unit denoted generally by 62 is received in the bearing bushing 42. In the embodiment illustrated, the bearing unit 62 includes a bearing ring 64 which receives and radially supports the first pivot shaft end portion 48, and is thus configured as a plain bearing unit. The bearing ring 64 is received in the bearing bushing 42 with an interference fit, and thus held in a defined axial position on the circumferential wall 56 of the bearing bushing 42. The pivot shaft 18 may be supported axially on the bearing ring 64 by way of a flange-like pivot shaft head 66 which is provided on the first pivot shaft end portion 48. A preload force that holds the pivot shaft head 66 of the pivot shaft 18 in contact with the bearing ring 64 may be provided by a preload spring 68 which acts between the pivot shaft 18 or the coupling part 36, on the one hand, and the drive shaft 34 or the coupling part 38, on the other hand, such that the defined position of the bearing ring 64 in the bearing bushing 42 also determines a defined position of the pivot shaft 18, and thus of the butterfly valve 16 as a whole, in the butterfly valve housing 14.

To provide a gas-tight closure in the first bearing region 28, an annular-disk-shaped sealing element constructed with elastomer material is furthermore provided, which is denoted generally by 70. The sealing element 70 is held or clamped with a holding portion 72 between the bearing ring 64 and the base 58 of the bearing bushing 42. By way of a sealing portion 74, the sealing element 70 lies, radially at the inside, against an outer circumferential surface of the pivot shaft 18 under radial preload. An opening 76 through which the pivot shaft 18 extends is formed in the sealing portion 74. In FIG. 3, a bearing play formed between the bearing ring 64 and the pivot shaft 18 is illustrated on an exaggerated scale in order to better illustrate the construction of the sealing element 70.

As a result of the sealing element 70 being subjected to axial load via the bearing ring 64 and the holding portion 72 being clamped axially between the bearing ring 64 and the base 58, the sealing element 70, which is in principle deformable but which is substantially not compressible, is subjected to load in a radially inward direction, such that the holding portion 74 is pressed with greater intensity against an outer circumferential surface of the pivot shaft 18. To achieve areal abutting contact between the sealing element 70 and the base 58, the base 58 is substantially planar, and oriented orthogonally with respect to the pivot shaft axis A, in its region that axially supports the sealing element 70. Correspondingly, the bearing ring 64 is also substantially planar, and oriented orthogonally with respect to the pivot shaft axis A, at its end side which presses the sealing element 70 against the base 58.

Correspondingly to the substantially planar form of the base 58, the butterfly valve housing 14 may also, in its region that supports the bearing bushing 42, be substantially planar and oriented orthogonally with respect to the pivot shaft axis A. In particular, this also applies if the bearing bushing 42 has no base, and the sealing element 70 is thus pressed against the outer circumferential surface 54 of the butterfly valve housing 14 by the bearing ring 64.

In order to be able to reliably maintain the state in which the sealing element 70 is pressed radially against the pivot shaft 18 by axial exertion of load, the bearing ring 64 is received in the bearing bushing 42 with an interference fit, as already stated. This interference fit, or the friction force generated here between the bearing ring 64 and the circumferential wall 56 of the bearing bushing 42, is of such intensity that, when a force F that is applied in order to press the bearing ring 64 in is withdrawn after the bearing ring 64 has been pressed in, the bearing ring 64 reliably remains in its position in the bearing bushing 42 in which the bearing ring exerts axial load on, and thus radially inwardly deforms, the sealing element 70.

In the construction of the butterfly valve assembly 10 illustrated in FIGS. 2 and 3, the bearing ring 64, and with it the sealing element 70, can be positioned in the bearing bushing 42 before the pivot shaft is arranged on the butterfly valve housing 14. Alternatively, if the bearing bushing 42 has already been attached to the butterfly valve housing 14, it is possible for the pivot shaft 18 to firstly be positioned in the butterfly valve housing 14, and thus with the pivot shaft end portion 48 in the bearing bushing 42, before the bearing ring 64 and the sealing element 70 are positioned in the bearing bushing 42. In order that the pivot shaft head 66 does not pose an obstruction during the assembly process, it is possible for the pivot shaft head to be arranged on the pivot shaft 18, and fixed thereto for example by welding, only after the pivot shaft 18 has been positioned in the two bearing regions 28, 30.

In principle, such a structure could also be provided in the second bearing region 30. Since it is however not intended for the pivot shaft 18 to be led out in the second bearing region 30, a gas-tight closure can for example also be achieved by virtue of the bearing bushing 44 of the second bearing region 30 completely encapsulating, that is, also axially encapsulating, the second pivot shaft end portion, for example by virtue of a cover which axially closes off the bearing bushing 44 being provided on a circumferential wall of the bearing bushing 44.

A butterfly valve assembly constructed in accordance with the disclosure may also be used in other applications, in particular also in the case of static fuel cell systems.

It is understood that the foregoing description is that of the preferred embodiments of the invention and that various changes and modifications may be made thereto without departing from the spirit and scope of the invention as defined in the appended claims.

1. A butterfly valve assembly comprising:
a butterfly valve housing defining a channel for accommodating a flow of gas therethrough;
a butterfly valve adjustable in said butterfly valve housing between a closed position preventing said flow of gas through said channel and at least one open position opening up said channel for allowing passage of said flow of gas through said channel;
a pivot shaft rotatable about a pivot shaft axis (A) and having first and second pivot shaft end portions corresponding to first and second bearing regions;
said butterfly valve having a disk-shaped butterfly valve element supported on said pivot shaft;
a pivot shaft drive;
said first pivot shaft end portion being coupled to said pivot shaft drive and being rotatably supported about said pivot shaft axis (A) on said butterfly valve housing in said first bearing region;
said second pivot shaft end portion being rotatably supported about said pivot shaft axis (A) on said butterfly valve housing in said second bearing region;
at least one of said first and second bearing regions including a bearing unit rotatably supporting said pivot shaft;
said pivot shaft having an outer peripheral surface; and,
at least one seal subject to an axial load by said bearing unit and lying against said outer peripheral surface of said pivot shaft.

2. The butterfly valve assembly of claim 1, wherein said first bearing region includes said bearing unit.

3. The butterfly valve assembly of claim 1, wherein at least one of the following applies:
i) said at least one seal annularly surrounds said pivot shaft axis (A); and,
ii) said bearing unit annularly surrounds said pivot shaft axis (A).

4. The butterfly valve assembly of claim 1, wherein said at least one seal includes a holding portion subjected to said axial load of said bearing unit and a sealing portion lying against said pivot shaft.

5. The butterfly valve assembly of claim 4, wherein said holding portion extends radially and said sealing portion extends radially inward from said holding portion toward said pivot shaft.

6. The butterfly valve assembly of claim 4, wherein said at least one bearing region includes a bearing bushing having a base and said bearing unit includes at least one bearing ring; and, said holding portion of said at least one seal is held according to at least one of the following: i) between said at least one bearing ring and said base; and, ii) between said at least one bearing ring and said butterfly valve housing.

7. The butterfly valve assembly of claim 6, wherein, said at least one seal defines a support region whereat said at least one seal is supported; and, in said support region, at least one of the following applies:
i) said base of said bearing bushing; and,
ii) said butterfly valve housing
is oriented orthogonally with respect to said pivot shaft axis (A) and is planar.

8. The butterfly valve assembly of claim 6, wherein said at least one bearing ring is held in said bearing bushing with an interference fit.

9. The butterfly valve assembly of claim 1, wherein said bearing unit is a plain bearing unit.

10. The butterfly valve assembly of claim 1, wherein said at least one seal is made with elastomer material.

11. The butterfly valve assembly of claim 1, wherein said butterfly valve assembly is for a gas flow in a fuel cell system in a vehicle.

12. A method for making a butterfly valve assembly that includes a butterfly valve housing defining a channel for accommodating a flow of gas therethrough; a butterfly valve adjustable in said butterfly valve housing between a closed position preventing said flow of gas through said channel and at least one open position opening up said channel for allowing passage of said flow of gas through said channel; a pivot shaft rotatable about a pivot shaft axis (A) and having first and second pivot shaft end portions corresponding to first and second bearing regions; said butterfly valve having a disk-shaped butterfly valve element supported on said pivot shaft; a pivot shaft drive; said first pivot shaft end portion being coupled to said pivot shaft drive and being rotatably supported about said pivot shaft axis (A) on said butterfly valve housing in said first bearing region; said second pivot shaft end portion being rotatably supported about said pivot shaft axis (A) on said butterfly valve housing in said second bearing region; at least one of said first and second bearing regions including a bearing unit rotatably supporting said pivot shaft; said pivot shaft having an outer peripheral surface; and, at least one seal subject to an axial load by said bearing unit and lying against said outer peripheral surface of said pivot shaft; the method comprising the steps of:
a) arranging said at least one seal in a bearing bushing of at least one of said first and second bearing regions; and,
b) pressing at least one bearing ring of said bearing unit into said bearing bushing so as to cause said at least one bearing ring to subject said at least one seal to axial load to deform said at least one seal radially inward.

13. The method of claim 12, wherein said method steps a) and b) are carried out after said pivot shaft has been positioned so as to engage with one of said pivot shaft end portions into said bearing bushing of said at least one bearing region.

14. The method of claim 12, wherein said method steps a) and b) are carried out before said pivot shaft is positioned so as to engage with one of said first and second pivot shaft end portions into said bearing bushing of said at least one bearing region.

15. The method of claim 12, wherein said butterfly valve assembly is for a gas flow in a fuel cell system in a vehicle.

16. A fuel cell system comprising:
a fuel cell; and,
at least one butterfly valve assembly associated with said fuel cell;
the at least one butterfly valve assembly including:
a butterfly valve housing defining a channel for accommodating a flow of gas therethrough;
a butterfly valve adjustable in said butterfly valve housing between a closed position preventing said flow of gas through said channel and at least one open position opening up said channel for allowing passage of said flow of gas through said channel;
a pivot shaft rotatable about a pivot shaft axis (A) and having first and second pivot shaft end portions corresponding to first and second bearing regions;
said butterfly valve having a disk-shaped butterfly valve element supported on said pivot shaft;
a pivot shaft drive;
said first pivot shaft end portion being coupled to said pivot shaft drive and being rotatably supported about said pivot shaft axis (A) on said butterfly valve housing in said first bearing region;
said second pivot shaft end portion being rotatably supported about said pivot shaft axis (A) on said butterfly valve housing in said second bearing region;
at least one of said first and second bearing regions including a bearing unit rotatably supporting said pivot shaft;
said pivot shaft having an outer peripheral surface; and,
at least one seal subject to an axial load by said bearing unit and lying against said outer peripheral surface of said pivot shaft.

17. The fuel cell system of claim 16, wherein said fuel cell system is for a vehicle.
